(19) United States
(12) Patent Application Publication
(10) Pub. No.: US 2010/0116554 A1
(43) Pub. Date: May 13, 2010

(54) Turbo-gear for speedy drilling wells

(76) Inventor: Yuriy Yatsenko, Philadelphia, PA (US)

Correspondence Address: Aleksandr Smushkovich, POB 140505, Brooklyn, NY, 11214, US

(21) Appl. No.: 12/291,239

(22) Filed: Nov. 7, 2008

(51) Int. Cl. E21B 4/02; F03B 13/02

(52) U.S. Cl. 175/107; 173/218

(57) ABSTRACT

A turbo-gear supplied with operating fluid for driving a drill bit is proposed. It preferably comprises a non-rotatable casing, an upper shaft rotatably mounted in the casing, coupled with blades configured to receive pressure of the operating fluid causing rotation of the upper shaft, a lower shaft mounted in the casing, having inside a cylindrical channel, an intermediate shaft rotatably mounted in the casing, disposed below the upper shaft and above the lower shaft. The shafts are associated with each other through conventional gears having predetermined transmission coefficients. The inner space of the turbo-gear is configured to pass the operating fluid therethrough. Preferably, the turbo-gear is combined with a bushing-connector shaped as a hollow cylinder, having means for assembling with the turbo-gear and the bit. The turbo-gear is assembled with a non-rotatable string of pipes, through which the operating fluid is supplied. The turbo-gear allows extending the lifespan of pipes.

### TECHNICAL FIELD

The invention relates to oil and gas extracting, and water supply industries, specifically to downhole drilling devices deployed for the fast drilling of deep wells.

### BACKGROUND OF THE INVENTION

There are known many different machines and devices for drilling oil, gas, and water wells. A traditional device is usually composed of a string consisting of a plurality of tubular pipes driven by a power unit typically located on the surface. The power unit provides rotation of the pipes in turn revolving a drilling bit that actually performs the drilling.

A drawback of such a device is that the rotating pipes are engaged with the walls of the well and quickly worn and sometimes break. This involves significant expenses for their frequent replacement and loss of operating time of the equipment.

The primary purpose of the present invention is to essentially reduce such expenses. Other purposes of the invention might become apparent to a skilled artisan upon learning the present disclosure.

### BRIEF SUMMARY OF THE INVENTION

The mentioned purpose is achieved by providing an inventive device, which device in preferred embodiments comprising: a specifically designed turbo-gear downwardly attachable to a bushing-connector and upwardly attachable to a non-rotatable string of pipes having a clearance between their outer walls and the inner walls of the well; and the bushing-connector downwardly attachable to a drilling bit. Operating fluid, supplied via the string pipes, is then passed via the inventive device and the drilling bit, and causes rotation of the turbo-gear that through the bushing-connector revolves the drilling bit. In alternative embodiments, the drilling bit can be immediately connected to the turbo-gear without deployment of the bushing-connector, or another connection means can be used instead.

The operating fluid is preferably utilized for washing up solid earth pieces and particles resulted from the drilling and removing them from the well onto the surface through the aforementioned clearance. The operating fluid can be pumped by a suitable pump, whose power can preferably be controlled.

The turbo-gear comprises a substantially vertically disposed cylindrical shell having an upper screw threading for attachment to the non-rotatable string of pipes, and a non-rotatable cylindrical hull fixedly enclosed into the shell. The shell and the hull are preferably made of suitable metal. In optional embodiments, the shell and the hull can be combined in one tubular casing member.

The turbo-gear generally comprises an upper shaft, a number of intermediate shafts, and a lower shaft. The number of intermediate shafts can be 0, 1, 2, etc. to provide a predetermined torque essentially to the drilling bit. The upper, intermediate, and lower shafts are associated with each other through conventional gears for reduction of the speed of rotation to a predetermined amount and respectively increasing the torque applied to the drilling bit.

In preferred embodiments, the upper shaft is rotatably mounted in the top of the hull. The upper shaft is coupled with suitable blades fixedly mounted on its surface and so configured that are capable to receive pressure of the through flow of operating fluid causing rotation of the upper shaft.

The upper shaft, in preferred embodiments, is associated through a first conventional gear (preferably, tooth gearing) with an intermediate shaft rotatably mounted substantially in the middle region of the hull below the upper shaft. The first gear preferably has a transmission coefficient of 1:2, i.e. the rotation speed is diminished two times.

The intermediate shaft is associated through a second conventional gear (preferably, tooth gearing) with a lower (main) shaft rotatably mounted substantially in the lower region of the hull below the intermediate shaft. The second gear preferably has a transmission coefficient of 1:2, i.e. the rotation speed is also diminished two times. The lower shaft has inside a cylindrical channel made along the central axe thereof, and has a lower screw threading made at the bottom end of the lower shaft. Therefore, the turbo-gear is so designed that the configuration of its inner space enables passing the flow of operating fluid therethrough.

The bushing-connector is shaped as a hollow cylinder having a top screw threading for connection with the lower threading of the lower shaft, and having a bottom screw threading for connection with the drilling bit. In optional embodiments, the turbo-gear can be assembled with the string of pipes and with the bushing-connector by other suitable fasten means capable of replacement of the screw threading.

The inventive device is particulary useful for drilling wells having diameters in the range of from 250 mm to 500 mm. For small depths of the wells the operating fluid might be chosen in the form of compressed air, whereas for deep wells a suitable type of liquid should preferably be used.

### BRIEF DESCRIPTION OF THE DRAWINGS

FIG. 1 is a general sectional view of the turbo-gear, according to a preferred embodiment of the invention.

FIG. 2 is a sectional view of the bushing-connector, according to a preferred embodiment of the invention.

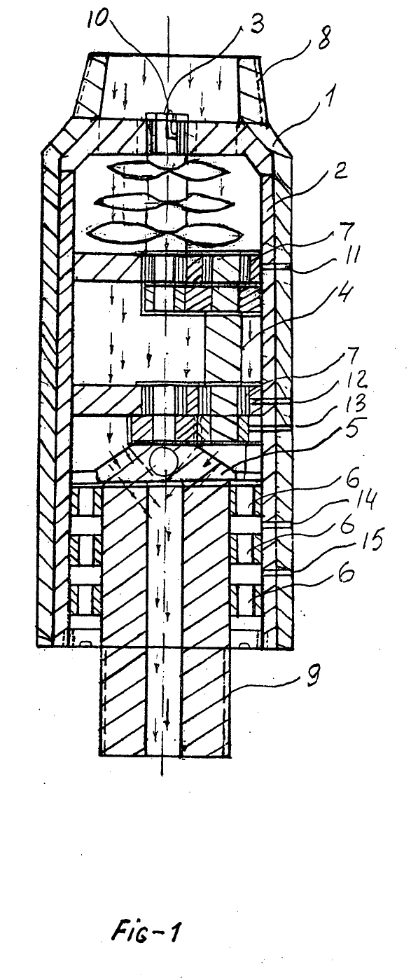

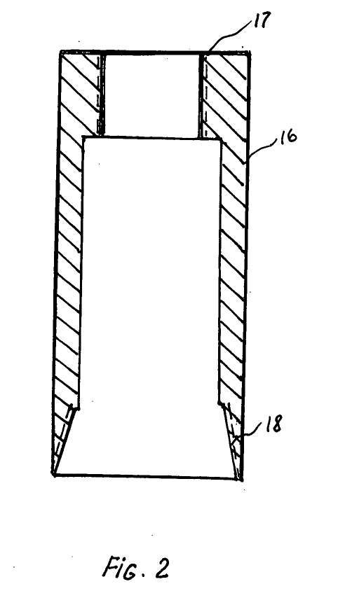

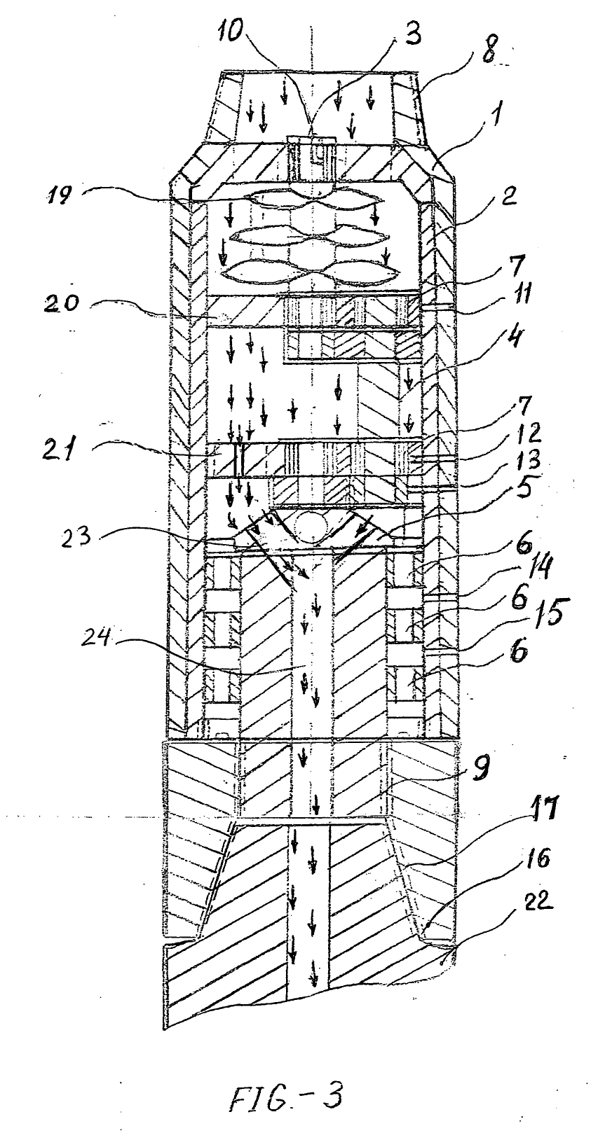

Each reference numeral indicated on FIGS. 1-2 is designated to an element of the inventive structure described herein below. A first time introduced reference numeral in the description is enclosed into parentheses.

### DETAIL DESCRIPTION OF A PREFERRED EMBODIMENT OF THE INVENTION

While the invention may be susceptible to embodiment in different forms, there is shown in the drawing, and will be described in detail herein, a specific embodiment of the present invention, with the understanding that the present disclosure is to be considered an exemplification of the principles of the invention, and is not intended to limit the invention to that as illustrated and described herein.

In a preferred embodiment illustrated on FIGS. 1 and 2, the inventive device includes a turbo-gear comprising a substantially vertically disposed non-rotatable cylindrical shell (1) having an upper screw threading (8) for attachment to a non-rotatable string of pipes (not illustrated), and a non-rotatable cylindrical hull (2) fixedly enclosed into the shell 1.

In preferred embodiments, the turbo-gear comprises an upper shaft (3) rotatably mounted on the top disc of the hull 2. The top disc has predetermined orifices to pass the flow of operating fluid. The upper shaft 3 is coupled with a plurality of suitable blades (19) fixedly disposed on its surface and so configured that are capable to receive pressure of the through flow of operating fluid (shown by arrows on FIG. 1) causing rotation of the upper shaft 3.

The upper shaft 3 is associated through a first tooth gear (20) with an intermediate shaft (4) rotatably mounted substantially in the middle region of the hull 2 below the upper shaft. The first gear 20 preferably has a first transmission coefficient of 1:2. Only one intermediate shaft 4 is used in this preferred embodiment.

The intermediate shaft 4 is associated through a second tooth gear (21) with a lower shaft (5) rotatably mounted substantially in the lower region of the hull 2 below the intermediate shaft 4. The second gear 21 preferably has a second transmission coefficient of 1:2. The lower shaft 5 has inside a cylindrical channel made along the central axe thereof, and has a lower screw threading (9) made at the bottom end of the lower shaft 5. The cylindrical channel is used to pass the flow of operating fluid through the shaft 5 essentially to a conventional drilling bit.

In a preferred embodiment illustrated on FIG. 2, the inventive device includes a bushing-connector (16) shaped substantially as a hollow cylinder having a top screw threading (17) for connection with the lower threading 9 of the lower shaft 5, and having a bottom screw threading (18) for connection with a conventional drilling bit (not illustrated).

In a preferred embodiment illustrated on FIG. 1, roll bearings (6) are fixedly mounted in the lower region of the hull 2, which bearings 6 support the lower shaft 5. The intermediate shaft 4 and the upper shaft 3 are supported by needle bearings (7) mounted on two horizontally disposed discs fixed in the middle portion of the hull 2. The two discs have predetermined orifices to pass the flow of operating fluid. Therefore, the inner space of the inventive turbo-gear is so configured that is capable to pass the flow of operating fluid therethrough.

As depicted on FIG. 1, the turbo-gear comprises conventional pressure lubricators (10-15), mounted in corresponding places of the turbo-gear to provide lubrication of the bearings.

The operating fluid is pumped via the string pipes (not illustrated), the inner space of the turbo-gear, and the drilling bit, and by acting upon the blades 19 causes rotation of the upper 3, intermediate 4, and lower 5 shafts. The lower shaft 5 through the bushing-connector 16 drives the drilling bit. The operating fluid is then utilized for washing up solid earth pieces and particles resulted from the drilling and removing them from the well onto the surface through the clearance formed between the outer walls of the string pipes and the inner walls of the well.

1. A turbo-gear supplied with a flow of operating fluid substantially for driving a drill bit, said turbo-gear comprising:
a non-rotatable casing means for housing said turbo-gear, said casing means include an upper portion, a middle portion, and a lower portion;
an upper shaft rotatably mounted in the upper portion of said casing means, said upper shaft is coupled with blades fixedly mounted on the upper shaft, said blades are configured to receive pressure of said flow of operating fluid causing rotation of said upper shaft;
a lower shaft rotatably mounted in the lower portion of said casing means, said lower shaft has inside a number of inclined channels connected to a central channel made along the central axe thereof; and
a number of intermediate shafts rotatably mounted in the middle portion of said casing means, said intermediate shafts are disposed below said upper shaft and above said lower shaft, said intermediate shafts are associated with -the upper shaft, with -the lower shaft, and with -each other through conventional gears each having a predetermined transmission coefficient;
wherein said operating fluid flows via the upper portion, the middle portion, the inclined channels, and the cylindrical channel.

2. The turbo-gear according to claim 1, wherein
said turbo-gear comprising one intermediate shaft associated with said upper shaft through a first tooth gear having a first transmission coefficient of 1:2, and associated with said lower shaft through a second tooth gear having a second transmission coefficient of 1:2.

3. A device supplied with a flow of operating fluid substantially for driving a drill bit, said device comprising:
a turbo-gear according to claim 1; and
a bushing-connector essentially shaped as a hollow cylinder having means for assembling with said turbo-gear and with said drill bit.

4. A device supplied with a flow of operating fluid substantially for driving a drill bit, said device comprising:
a turbo-gear according to claim 2; and
a bushing-connector essentially shaped as a hollow cylinder having means for assembling with said turbo-gear and with said drill bit.
